(19) United States
(12) Patent Application Publication
(10) Pub. No.: US 2021/0028520 A1
(43) Pub. Date: Jan. 28, 2021

(54) SYSTEM INCLUDING A SYSTEM SUPPORT AND A STORAGE BATTERY

(71) Applicant: Mahle International GmbH, Stuttgart (DE)

(72) Inventors: Peter Geskes, Ostfildern (DE); Johannes Weinmann, Stuttgart (DE)

(21) Appl. No.: 16/937,460

(22) Filed: Jul. 23, 2020

(30) Foreign Application Priority Data
Jul. 24, 2019 (DE) 10 2019 210 981.0
Dec. 19, 2019 (DE) 10 2019 220 124.5

(51) Int. Cl. H01M 10/6568; H01M 2/02; H01M 2/10; H01M 10/613

(52) U.S. Cl. CPC H01M 10/6568; H01M 2/0245; H01M 10/625; H01M 2/1077; H01M 10/613; H01M 2/024

(57) ABSTRACT

A system includes a system support and a storage battery which is supported and held by the system support. A compact design with improved resistance and increased efficiency of the system are produced by way of the system support having a hollow profile which extends in a longitudinal direction, wherein at least one flow path for a temperature-control fluid is delimited in the hollow profile, the temperature of the storage battery being controlled by the said temperature-control fluid during operation. In addition, a system support of this kind is provided.

### CROSS REFERENCE TO RELATED APPLICATIONS

This application claims priority to German patent applications DE 10 2019 210 981.0, filed on Jul. 24, 2019 and DE 10 2019 220 124.5, filed on Dec. 19, 2019, the entire content of which is incorporated herein by reference.

### TECHNICAL FIELD

The present disclosure relates to a system including a storage battery and a system support for supporting the storage battery. The disclosure additionally relates to a system support of this kind.

### BACKGROUND

Storage batteries, also called rechargeable batteries, usually have a plurality of storage battery cells which can be combined to form a cell stack and are accommodated in a housing of the storage battery. Storage batteries of this kind can be used in a wide variety of applications. Here, consideration can be given, in particular, to the use of storage batteries in motor vehicles in which the storage battery can serve, for example, to drive the motor vehicle.

In the associated application, for example in a motor vehicle, storage batteries are usually attached and fastened with supports which form a system with the storage battery. In a motor vehicle, it is usual, for example, to attach the system including the support, also called system support in the text which follows, to a motor vehicle support, in particular to a crossmember of the motor vehicle, in such a way that the storage battery is supported with the system support motor vehicle support.

Particularly for reducing the weight of the system and/or for improving the crash behaviour, system supports of this kind are of at least partially hollow design and therefore have a hollow profile. In this case, storage batteries can be attached to the system support by using screws which can have an outside diameter which decreases in size in a stepped manner along the extent.

### SUMMARY

The present disclosure addresses a problem of specifying improved or at least other embodiments for a system including a storage battery and a system support of the kind mentioned at the outset and for a system support of this kind, which embodiments are distinguished, in particular, by a more compact and/or more simple design and/or by an extended service life of the system.

According to an aspect of the disclosure, this problem is solved by a system and a system support of the system as described herein.

The present disclosure is based on the general idea of, in a system including a system support and a storage battery which is supported or held by the system support, providing the system support with a hollow profile which supports the storage battery and in which at least one flow path is formed, through which flow path an associated fluid flows during operation, wherein a reinforcing strip for mechanically reinforcing the hollow profile is additionally arranged in the hollow profile. Owing to the integration of the flow path in the hollow profile, the system support serves to guide an associated fluid at the same time, so that the system is of compact design in spite of the integration of the fluid guidance. In addition, a temperature of the storage battery can be controlled by the fluid at the same time, so that the service life and/or the stability of the storage battery are/is increased. The reinforcing strip leads to mechanical stabilization of the hollow profile and therefore of the system support, so that the service life and the stability of the hollow profile and therefore of the system support and of the entire system are also increased. The weight of the system is reduced at the same time.

In accordance with the idea of the disclosure, the system includes the system support and the storage battery. The storage battery has a housing in which at least two rechargeable storage battery cells, such as pouch cells, prismatic cells, round cells and the like for example, are arranged. The system support has the hollow profile which, in its interior, delimits at least one flow path of a temperature-control fluid and extends in a longitudinal direction. The storage battery is attached to the hollow profile on the outside of the hollow profile in such a way that the hollow profile supports the storage battery. In this case, the temperature-control fluid flows along the flow path and to the storage battery in such a way that it controls the temperature of, that is to say cools and/or heats, the storage battery. Accordingly, the storage battery is fluidically connected to the at least one flow path. In particular, the storage battery is fluidically connected to the interior of the hollow profile. The system support further has at least one reinforcing strip within the hollow profile, which reinforcing strip bears against the hollow profile and extends in the longitudinal direction.

The system can be attached and/or fastened in principle in an associated application by the system support.

Here, consideration can be given to a motor vehicle in which the system support is attached and/or fastened to a vehicle body. In particular, the system support can be attached and/or fastened to a motor vehicle support of the motor vehicle, for example to a crossmember of the motor vehicle. In this case, the system support can run transversely in relation to the motor vehicle support. The system support can therefore run, in particular, in the longitudinal direction of the motor vehicle and can be attached and/or fastened to the crossmember. Here, the system support may be a support of the motor vehicle, in particular a longitudinal support of the motor vehicle.

It goes without saying that the system can have two or more storage batteries of this kind. The respective storage battery expediently has a housing in which at least two storage battery cells are arranged. The respective storage battery is typically fluidically connected to at least one flow path.

Embodiments in which the hollow profile, in the interior, delimits two flow paths which are fluidically separated from one another within the hollow profile and through each of which a temperature-control fluid, in particular the same temperature-control fluid, flows during operation have proven to be advantageous. Therefore, it is possible, for example, to allow the temperature-control fluid to flow in one direction along one of the flow paths and in the opposite direction along the other flow path within the hollow profile. For example, the temperature-control fluid can flow to the storage battery along one of the flow paths and away from the storage battery along the other flow path. In this variant, the storage battery is expediently fluidically connected to both flow paths. As an alternative or in addition, it is conceivable to provide the system with at least two storage batteries, wherein one of the storage batteries is fluidically connected to one of the flow paths and the other storage battery is fluidically connected to the other flow path.

According to an aspect of the disclosure, the flow paths are separated from one another in a transverse direction which runs transversely in relation to the longitudinal direction.

To this end, a separating wall can run in the longitudinal direction within the hollow profile and extend in a vertical direction which runs transversely in relation to the longitudinal direction and transversely in relation to the transverse direction. In this case, the two flow paths can be delimited and separated by a common separating wall.

It is further conceivable to provide an associated separating wall of this kind for the respective flow path, so that two separating walls of this kind are arranged within the hollow profile. It is conceivable here to arrange the separating walls in a manner spaced apart from one another in the transverse direction. Therefore, a cavity or a gap is formed between the separating walls, so that the flow paths are thermally separated from one another in an improved manner.

The at least one reinforcing strip is advantageously fluidically separated from the at least one flow path. Therefore, damage to the reinforcing strip caused by the temperature-control fluid is avoided or at least reduced. As a result, the reinforcing strip has an extended service life and/or the reinforcing strip can be produced in a more cost-effective manner. In addition, the use of seals for sealing-off the flow path to the outside can be dispensed with or the use of the said seals can at least be reduced as a result.

The extent of the hollow profile in the longitudinal direction means, in particular, that the longitudinal extent of the hollow profile is in the longitudinal direction. In particular, fluid can therefore flow through the hollow profile through the at least one flow path along the longitudinal extent. It is typical here that the extent of the hollow profile in the longitudinal direction is larger than the extent of the hollow profile in the transverse direction and in the vertical direction. It is further typical that the extent of the hollow profile in the vertical direction is larger than the extent of the hollow profile in the transverse direction.

The at least one reinforcing strip extends in the longitudinal direction. It is further typical that the reinforcing strip extends in the transverse direction and therefore transversely in relation to the at least one separating wall.

The at least one reinforcing strip typically extends in the longitudinal direction and further transversely in relation to the longitudinal direction in that direction in which the hollow profile has the smaller extent. That is to say that when an extent of the hollow profile is larger in the vertical direction than in the transverse direction, the reinforcing strip extends in the longitudinal direction and in the transverse direction. In this case, the longitudinal extent of the reinforcing strip is along the longitudinal direction.

The system support can have only one single reinforcing strip of this kind in principle.

It is typical that the system support has two reinforcing strips of this kind, which are opposite transversely to the longitudinal direction, in the hollow profile. This leads to more uniform and improved mechanical stabilization and reinforcement of the hollow profile. It is typical that the reinforcing strips are arranged opposite in that direction of the hollow profile which has the larger extent transversely in relation to the longitudinal direction. When the hollow profile has a larger extent in the longitudinal direction than in relation to the transverse direction, the reinforcing strips are therefore arranged opposite in the vertical direction. Therefore, improved mechanical stability of the hollow profile is achieved.

Exemplary embodiments in which the hollow profile has a frame for at least one of the at least one reinforcing strips, in which frame the reinforcing strip is accommodated in an interlocking manner transversely in relation to the longitudinal direction, are typical. In particular, the reinforcing strip is accommodated in an interlocking manner in the vertical direction in the associated frame. Simplified and stable arrangement of the reinforcing strip in the hollow profile is achieved in this way. It is typical here when the at least one frame and/or the at least one reinforcing strip are/is respectively fluidically separated from the at least one flow path.

Exemplary embodiments in which the system support is fastened to the associated application, for example to the motor vehicle, with the aid of at least one of the reinforcing strips are typical. This leads to a stable connection between the system support and the associated application and/or to reduced mechanical loading of the hollow profile.

To this end, at least one of the reinforcing strips can have at least one strip opening and the hollow profile can have a profile opening which is associated with the strip opening, is open to the outside and is in alignment with the strip opening. The reinforcing strip typically has at least two, advantageously a plurality of, strip openings of this kind which are arranged in a manner spaced apart from one another in the longitudinal direction. The same applies to the profile openings of the hollow profile.

It is advantageous when an associated screw nut which is in alignment with the strip opening and the profile opening is attached to the reinforcing strip on that side of at least one of the strip openings that is averted from the profile opening. The screw nut is typically fixed to the reinforcing strip. Therefore, the respective system support can be screwed in the associated application in a simplified manner. Owing to the screw nut being fixed to the strip, separate fixing of the screw nut during screw-connection is not necessary here, so that the system support can be fastened in the associated application in a simplified, reliable and stable manner.

The respective storage battery can be supported or held on the hollow profile in any desired manner in principle.

It is typical that the system support has at least one shoulder which projects from the hollow profile on the outside and to which the storage battery is attached. In particular, the storage battery can rest on the shoulder. It is advantageous here when the shoulder projects from the hollow profile transversely in relation to the longitudinal direction. It is particularly typical that the shoulder projects from the hollow profile in that direction which runs transversely in relation to the longitudinal direction in which the hollow profile has the smaller extent. Therefore, if the hollow profile extends to a shorter extent in the transverse direction than in the vertical direction, it is typical that the shoulder projects in the transverse direction from the hollow profile on the outside.

It is advantageous that at least two shoulders of this kind which are averted from one another and which each support at least one storage battery project from the hollow profile. This leads to a compact and installation space-saving configuration of the system.

The fluidic connection between the respective storage battery and the at least one flow path can be configured in any desired manner in principle. The respective storage battery is typically fluidically connected to the flow path with the hollow profile. This leads to reduced thermal losses, so that a temperature of the storage battery is controlled more effectively.

To this end, the hollow profile, in particular in an outer wall, can have at least one flow opening for fluidically connecting the hollow profile, in particular of at least one of the flow paths, to the storage battery. If two flow paths are formed within the hollow profile, it is typical that at least one associated flow opening of this kind is provided for the respective flow path. It is further typical that at least two or more flow openings which are spaced apart from one another in the longitudinal direction are provided for at least one of the at least one flow paths. Therefore, a plurality of storage batteries can each be fluidically connected to the flow path and/or one storage battery can be connected to the flow path multiple times.

Exemplary embodiments in which the temperature-control fluid directly flows through at least one of the storage batteries for temperature control are typical. That is to say in particular that the temperature of the storage battery is controlled in the manner of immersion temperature control, in particular immersion cooling, in which at least one of the at least one storage battery cells is surrounded by the temperature-control fluid and the temperature thereof is controlled in this way.

At least one of the at least one flow paths within the hollow profile is typically delimited by a duct. The duct is advantageously formed by an outer wall of the hollow profile and a separating wall of this kind.

For the purpose of fluidically connecting the at least one flow path to at least one of the storage batteries, it is typical that a nozzle is attached to the flow opening. This leads to a simplified fluidic connection of the storage battery to the flow path. It is conceivable in this case to provide at least one nozzle for introducing the temperature-control fluid into the storage battery and at least one other nozzle for discharging the temperature-control fluid from the storage battery, which nozzles can differ in respect of their design and/or arrangement.

It goes without saying that the system can also have two or more system supports of this kind which are spaced apart from one another transversely in relation to the longitudinal direction, in particular in the transverse direction, wherein at least one storage battery can be arranged between two adjacent system supports, which storage battery is supported by the two system supports and/or which storage battery is fluidically connected to in each case at least one flow path of the system supports.

The respective reinforcing strip can be produced from steel. As an alternative or in addition, the respective reinforcing strip can be produced from aluminium.

The respective system support, in particular the respective hollow profile, can be produced from a metal or a metal alloy, for example from aluminium or an aluminium alloy.

It further goes without saying that, in addition to the system, a system support of this kind also forms part of the scope of this disclosure.

It goes without saying that the features mentioned above and those still to be explained below can be used not only in the respectively indicated combination, but also in other combinations or on their own, without departing from the scope of the present disclosure.

### BRIEF DESCRIPTION OF THE DRAWINGS

The disclosure will now be described with reference to the drawings wherein:

FIG. 1 shows an isometric view of a system including at least one storage battery and at least one system support according to an exemplary embodiment of the disclosure,

FIG. 2 shows a partially sectioned isometric view of the system in the region of one of the system supports,

FIG. 3 shows a cross section through the system support,

FIG. 4 shows a cross section through the system support in another exemplary embodiment,

FIG. 5 shows a further cross section of the system support shown in FIG. 3, and

FIG. 6 shows an isometric view of a reinforcing strip of the system.

### DESCRIPTION OF EXEMPLARY EMBODIMENTS

Exemplary embodiments of the disclosure illustrated in the drawings will be explained in more detail in the following description, wherein identical reference signs refer to identical or similar or functionally identical components.

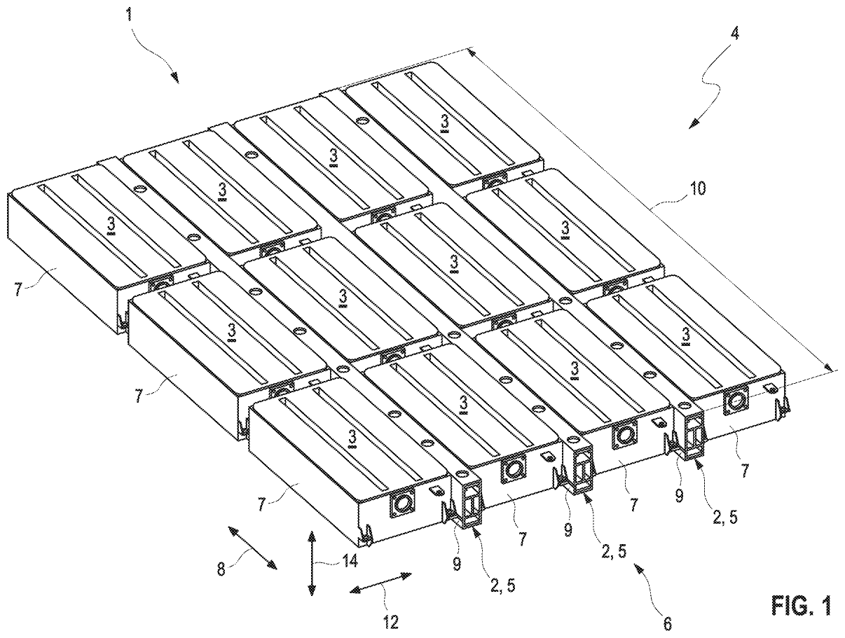

A system 1, as is shown in FIGS. 1 to 6, includes at least one system support 2 and at least one storage battery 3. In the exemplary embodiments, the system 1 is a constituent part of a motor vehicle 4. The respective system support 2 can be attached and fastened (not shown) to a vehicle body 6, which is otherwise not shown, in particular to at least one transverse support, not shown, of the motor vehicle 4. In particular, at least one of the system supports 2 may be a longitudinal support 5 of the vehicle body 6.

In the exemplary embodiment shown in FIG. 1, the system 1 has, purely by way of example, three system supports 2 and twelve storage batteries 3, wherein the system supports 2 and the storage batteries 3 are respectively of identical design. The respective storage battery 3 has a housing 7 in which at least two storage battery cells, not visible, such as pouch cells, prismatic cells, round cells and the like for example, are arranged and accommodated.

The respective system support 2 extends in a longitudinal direction 8 which can correspond to the longitudinal direction 8 of the motor vehicle 4. The respective system support 2 has a hollow profile 9. The system support 2, in particular the hollow profile 9, is of substantially cuboidal design. In this case, an extent 10 of the system support 2 in the longitudinal direction 8, also called the system support length 10 in the text which follows, is several times larger than an extent 11 of the system support 2 in a transverse direction 12 which runs transversely in relation to the longitudinal direction 8. In addition, the system support length 10 is larger than an extent 13 of the system support 2 in a vertical direction 14 which runs transversely in relation to the longitudinal direction 8 and transversely in relation to the transverse direction 12. In this case, the extent 13 of the system support 2, also called system support height 13 in the text which follows, is larger than the extent 11 of the system support 2, also called system support width 11 in the text which follows, in the exemplary embodiments shown. In particular, an extent 15 of the hollow profile 9 in the transverse direction 12, also called hollow profile width 15 in the text which follows, is smaller, in particular at most half the size, of the system support height 13. In the examples shown, the hollow profile 9 extends along the entire system support length 10 and the entire system support height 13.

In the exemplary embodiment shown in FIG. 1, the system supports 2 are arranged spaced apart, in particular equidistantly, from one another in the transverse direction 12, wherein the storage batteries 3 are arranged on outer walls 16, which are on the outside in the transverse direction 12, of the associated hollow profile 9 and are supported by shoulders 17 which project to the outside from the outer walls 16 in the transverse direction 12. In the exemplary embodiment shown in FIG. 1, three of the storage batteries 3 are arranged on each of the outer walls 16 and are supported by corresponding shoulders 17 in this case.

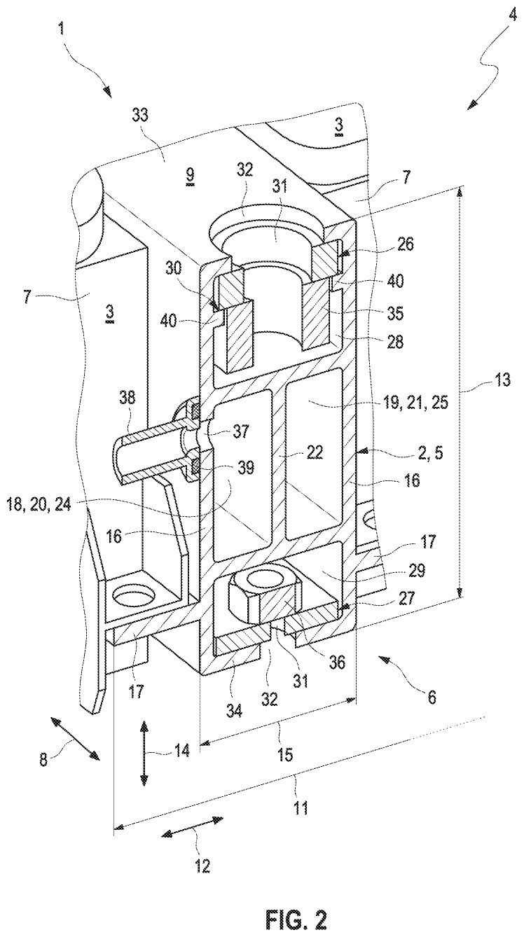

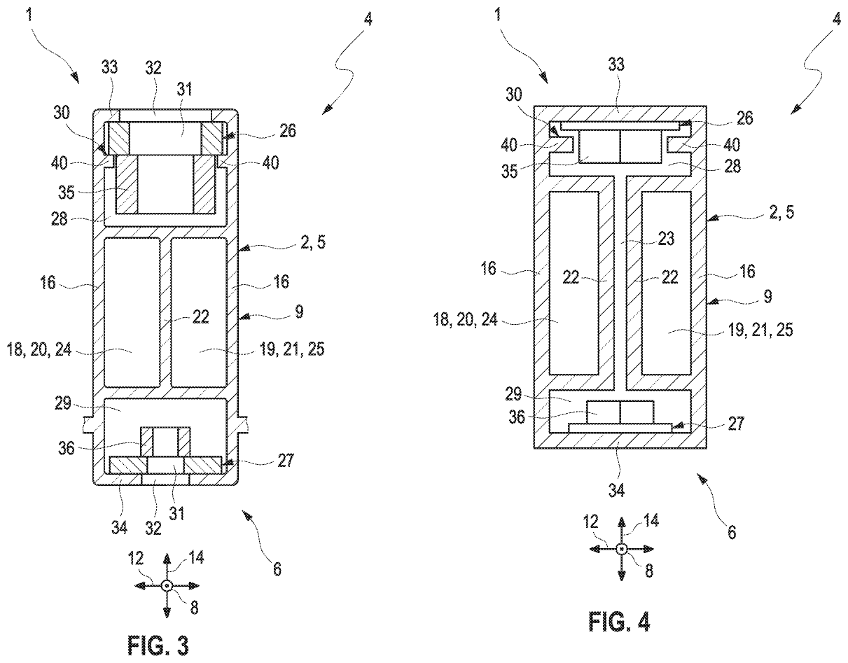

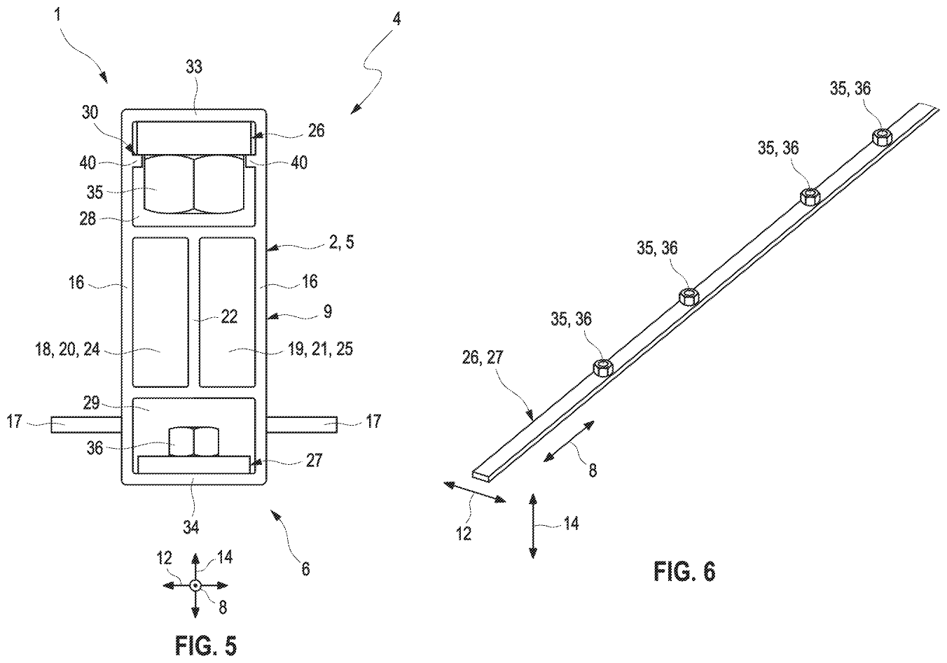

FIG. 2 shows a view of the system 1 in the region of one of the system supports 2 which is illustrated partially in section. FIG. 3 shows a cross section through the system support 2 outside the region of the shoulders 17, and FIG. 5 shows a section through the system support 2 in the region of shoulders 17. FIG. 4 shows a section through the system support in another exemplary embodiment.

The hollow profile 9 of the system support 2 delimits, in its interior, at least one flow path 18 and 19 of a temperature-control fluid for controlling the temperature of at least one of the storage batteries 3. To this end, the storage batteries 3 are each fluidically connected to at least one flow path 18 and 19. Owing to the fluidic connection of the respective storage battery 3 to the corresponding flow path 18 and 19, the flow path 18 and 19 also runs through the storage battery 3.

In the exemplary embodiments shown, a first flow path 18 and a second flow path 19 of the temperature-control fluid are delimited and separated from one another within the respective hollow profile 9. The respective flow path 18 and 19 is in this case delimited by an associated duct 20 and 21 in the hollow profile 9, which duct is formed by the hollow profile 9. A first duct 20 for the first flow path 18 is formed by one of the outer walls 16 and a second duct 21 is formed by the opposite outer wall 16. In addition, the ducts 20 and 21 are delimited by at least one separating wall 22 which runs within the hollow profile 9 and which extends in the longitudinal direction 8 and in the vertical direction 14. In the exemplary embodiment of FIGS. 1 to 3 and 5, the ducts 20 and 21 have a common separating wall 22 in this case, so that the flow paths 18 and 19 are delimited by a common separating wall 22 within the hollow profile 9. In the exemplary embodiment of FIG. 4, the respective duct 20 and 21 has an associated separating wall 22, wherein the separating walls 22 are spaced apart from one another and are separated from one another by a cavity 23. Here, one of the flow paths 18 and 19 can serve to feed the temperature-control fluid to the at least one storage battery 3, and the other flow path 19 can serve to discharge the temperature-control fluid from the at least one storage battery 3. That is to say, in particular, that the first duct 20 can be configured as a feed duct 24 for feeding the temperature-control fluid, and the second duct 21 can be configured as a return duct 25 for returning the temperature-control fluid to the storage batteries 3 and, respectively, from the storage batteries 3.

The system support 2 additionally has, within the hollow profile 9, at least one reinforcing strip 26 which bears against the hollow profile 9 and extends in the longitudinal direction 8. The reinforcing strip 26 provides mechanical stabilization and reinforcement of the hollow profile 9, so that the system support 2 as a whole can support the at least one storage battery 3 in a mechanically stable manner and without damage. In the exemplary embodiments shown, the respective system support 2 has two reinforcing strips 26 and 27 of this kind which are arranged opposite in the vertical direction 14, wherein the flow paths 18 and 19 and, respectively, the ducts 20 and 21 are arranged between the reinforcing strips 26 and 27 in the vertical direction 14. In this case, the respective reinforcing strip 26 and 27 is fluidically separated from the respective flow path 18 and 19. A reinforcing strip 26 and 27 of this kind is illustrated separately and isometrically in FIG. 6. In the exemplary embodiments shown, the hollow profile 9 has an associated recess 28 and 29 for the respective reinforcing strip 26 and 27. That is to say that the hollow profile 9 has an associated first recess 28 for a first of the reinforcing strips 26, and an associated second recess 29 for a second of the reinforcing strips 27. Here, the reinforcing strips 26 and 27 and the recesses 28 and 29 extend in the longitudinal direction 8. The recesses 28 and 29 are delimited by the outer walls 16 of the hollow profile 9. In the exemplary embodiment shown in FIGS. 1 to 3 and 5, the recesses 28 and 29 are separated from one another by the ducts 20 and 21. In the exemplary embodiment of FIG. 4, the recesses 28 and 29 are connected to one another by the cavity 23 between the ducts 20 and 21.

In the exemplary embodiments shown, a frame 30 is formed within the first recess 28 for the first reinforcing strip 26, the first reinforcing strip 26 being accommodated in an interlocking manner in the vertical direction 14 in the said frame. This in particular prevents the first reinforcing strip 26 from moving further into the interior of the hollow profile 9 in the vertical direction 14. The frame 30 can have two wings 40 which project inward, in particular in the transverse direction 12, and on which the associated reinforcing strip 26 and 27, that is to say the first reinforcing strip 26 in the exemplary embodiments shown, rests in an interlocking manner. Here, the wings 40 are spaced apart from one another in the transverse direction 12, wherein the screw nuts 35 of the first reinforcing strip 26 are arranged between the wings 40.

In the exemplary embodiments shown, the respective reinforcing strip 26 and 27 has at least one strip opening 31, and the hollow profile 9 has a profile opening 32 which is associated with the strip opening 31, is open to the outside and is in alignment with the associated strip opening 31. Accordingly, the respective profile opening 32 is formed in a wall 33 and 34 which is most closely adjacent to the associated strip opening 31 in the vertical direction 14. In the exemplary embodiments shown, the two reinforcing strips 26 and 27 each have a plurality of strip openings 31 of this kind which are arranged in a manner spaced apart from one another in the longitudinal direction 8. Accordingly, the hollow profile 9 has a plurality of profile openings 32 of this kind which are spaced apart from one another in the longitudinal direction 8. That is to say that the hollow profile 9 has profile openings 32 which are spaced apart from one another in the longitudinal direction 8 for the first reinforcing strip 26 on one of the walls 33, which wall is at the top in the vertical direction 14 and is also called the upper wall 33 in the text which follows, wherein the respective profile opening 32 is in alignment with one of the associated strip openings 31. In addition, the hollow profile 9 has a plurality of profile openings 32 on one of the walls 34, which wall is at the bottom in the vertical direction 14 and is also called the lower wall 34 in the text which follows, wherein the respective profile opening 32 is in alignment with an associated one of the strip openings 31. In the exemplary embodiments shown, the system support 2 additionally has an associated screw nut 35 and 36 for the respective profile opening 32 and therefore for the respective strip opening 31, wherein the respective screw nut 35 and 36 is in alignment with the associated strip opening 31 and therefore with the associated profile opening 32. Therefore, the system support 2 can be fastened and fixed in the motor vehicle 4 via the respective profile opening 32 and the associated strip opening 31 and the associated screw nut 35 and 36 with a thread, not shown, for example of a screw, not shown. It is typical here when the respective screw nut 35 and 36 is fixed to the associated reinforcing strip 26 and 27 in such a way that capture of the screw nuts 35 and 36 is dispensed with when interacting with the thread. That is to say that first screw nuts 35 are attached and fixed to the first reinforcing strip 26, wherein the respective first screw nut 35 is in alignment with an associated strip opening 31 of the first reinforcing strip 26 and the associated profile opening 32. In addition, second screw nuts 36 are attached and fixed to the second reinforcing strip 27, which second screw nuts are each in alignment with an associated strip opening 31 of the second reinforcing strip 27 and the associated profile opening 32. In the exemplary embodiment of FIGS. 1 to 3 and 5, the first screw nuts 35 of the first reinforcing strip 26 and the second screw nuts 36 of the second reinforcing strip 27 have different dimensions here. In particular, the first screw nuts 35 are larger than the second screw nuts 36. Accordingly, the strip openings 31 in the first reinforcing strip 26 and the profile openings 32 in the upper wall 33 are also larger than the strip openings 31 of the second reinforcing strip 27 and the profile openings 32 in the lower wall 34. In the exemplary embodiment of FIG. 4, the first reinforcing strip 26 and the second reinforcing strip 27 together with associated screw nuts 35 and 36 are of different design purely by way of example. This also applies to the profile openings 32 in the upper wall 33 and in the lower wall 34, wherein neither the profile openings 32 nor the strip openings 31 are visible in the illustrated sectional plane of FIG. 4.

As can be gathered from FIG. 3 in particular, the inside diameters of the profile openings 32, of the strip openings 31 and of the screw nuts 35 and 36 decrease from the outside to the inside in the vertical direction 14 in this case, so that the profile openings 32 each have a larger inside diameter than the associated strip openings 31 and screw nuts 35 and 36, and the strip openings 31 each have a larger inside diameter than the associated screw nuts 35 and 36.

As can be gathered from FIG. 2 in particular, the flow paths 18 and 19 and therefore the ducts 20 and 21 are fluidically connected to the storage batteries 3 via respectively associated openings in the outer walls 16, wherein these openings 37 are also referred to as flow openings 37 in the text which follows. In the view shown in FIG. 2, only one flow opening 37 of one of the outer walls 16 can be seen here. As can further be gathered from FIG. 2, an associated nozzle 38 can be attached to the respective flow opening 37, which nozzle projects from the associated separating wall 16 on the outside, in particular in the transverse direction 12, and can enter the associated storage battery 3. To this end, an associated opening, not shown, can be provided in the housing 7 of the associated storage battery 3. As can further be gathered from FIG. 2, an associated seal 39 can be attached to the respective nozzle 38 in order to seal off the flow opening 37 or the nozzle 38 to the outside.

It is understood that the foregoing description is that of the exemplary embodiments of the disclosure and that various changes and modifications may be made thereto without departing from the spirit and scope of the disclosure as defined in the appended claims.

What is claimed is:

1. A system comprising:
a system support; and
a storage battery which has a housing in which at least two rechargeable storage battery cells are arranged,
wherein the system support has a hollow profile which, in its interior, delimits at least one flow path of a temperature-control fluid and extends in a longitudinal direction,
wherein the storage battery is attached to the hollow profile on the outside of the hollow profile in such a way that the hollow profile supports the storage battery,
wherein the storage battery is fluidically connected to the at least one flow path, such that the flow path leads to temperature-control of the storage battery cells by the storage battery, and
wherein the system support has at least one reinforcing strip within the hollow profile, which reinforcing strip bears against the hollow profile and extends in the longitudinal direction.

2. The system according to claim 1, wherein the hollow profile delimits two flow paths which are separated from one another within the hollow profile.

3. The system according to claim 1, wherein the hollow profile has two, in particular opposite, reinforcing strips which are spaced apart from one another transversely in relation to the longitudinal direction.

4. The system according to claim 1, wherein the hollow profile has a frame for at least one of the at least one reinforcing strips, in which frame the reinforcing strip is accommodated in an interlocking manner transversely in relation to the longitudinal direction.

5. The system according to claim 1, wherein at least one of the at least one reinforcing strips has at least one strip opening and the hollow profile has a profile opening which is associated with the strip opening, is open to the outside, and is in alignment with the strip opening.

6. The system according to claim 5, wherein an associated screw nut which is in alignment with the strip opening and the associated profile opening is attached to the reinforcing strip on that side of at least one of the strip openings that is averted from the profile opening.

7. The system according to claim 1, wherein the system support has at least one shoulder which projects from the hollow profile on the outside and to which the storage battery is attached.

8. The system according to claim 1, wherein the hollow profile has at least one flow opening for fluidically connecting the hollow profile to the storage battery.

9. The system according to claim 8, wherein a nozzle is attached to the flow opening.

10. The system according to claim 1, wherein the system has at least two system supports and/or at least two storage batteries.

11. A system support of the system according to claim 1, comprising the hollow profile and the at least one reinforcing strip.
